(19) United States
(12) Patent Application Publication
(10) Pub. No.: US 2024/0258807 A1
(43) Pub. Date: Aug. 1, 2024

(54) MODULAR POWER SYSTEM

(71) Applicant: GLOBAL INDUSTRIAL DISTRIBUTION INC., Port Washington, NY (US)

(72) Inventors: Richard B. LEEDS, Port Washington, NY (US); Bruce B. ZUTLER, Port Washington, NY (US); Phillip C. LEE, Port Washington, NY (US)

(73) Assignee: GLOBAL INDUSTRIAL DISTRIBUTION INC., Port Washington, NY (US)

(21) Appl. No.: 18/101,994

(22) Filed: Jan. 26, 2023

(51) Int. Cl. H02J 7/00; H01M 10/46; H02J 7/02; H02J 7/35

(52) U.S. Cl. CPC H02J 7/0045; H01M 10/46; H02J 7/0013; H02J 7/02; H02J 7/35; H02J 2207/20

(57) ABSTRACT

A modular power system may include a power station; a first rigid frame configured to house the power station; a second rigid frame configured to engage the first rigid frame; a first battery configured to be mounted proximate to the power station and housed in the second rigid frame; a bottom frame engaging the first rigid frame and comprising a transportation element; and a top frame engaging the second rigid frame.

### FIELD

The present invention relates to a modular power system with enhanced capacity, durability, and mobility.

### BACKGROUND

Traditional power systems are typically not made for use in industrial settings, where capacity, durability, and mobility are all key to successful function. Traditional power systems are typically either stationary units, or ones that do not provide for durability to withstand industrial use, such as on construction sites. Industrial applications require power systems that can not only power equipment of varying sizes and types, but can also be easily maneuvered within or across different job site settings.

Accordingly, there is a need for improved modular power systems with enhanced capacity, durability, and mobility. Embodiments of the present disclosure may be directed to this and other considerations.

### SUMMARY

In accordance with certain embodiments of the disclosed invention, a modular power system is disclosed. The modular power system may include a power station, a first rigid frame configured to house the power station, a second rigid frame configured to engage the first rigid frame, a first battery configured to be mounted proximate to the power station and housed in the second rigid frame, a bottom frame engaging the first rigid frame and comprising a transportation element, and a top frame engaging the second rigid frame.

In accordance with certain embodiments of the disclosed invention, a modular power system is disclosed. The modular power system may include a power station having an inverter, a first rigid frame configured to house the power station, a bottom frame having a transportation element and interlocking to the first rigid frame, and a top frame interlocking to the first rigid frame opposite the bottom frame.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1A is a front right perspective view of an exemplary modular power system.

FIG. 1B is a rear right perspective view of the modular power system of FIG. 1A.

FIG. 1C is an exploded view of the modular power system of FIG. 1A.

FIG. 2A is a front right perspective view of an exemplary modular power system.

FIG. 2B is a rear right perspective view of the modular power system of FIG. 2A.

FIG. 3A is a perspective view of components of the modular power systems of FIGS. 1A-1C and 2A-2B.

FIG. 3B is a bottom view of the modular power systems of FIGS. 1A-1C and 2A-2B.

FIG. 3C is a top view of the modular power systems of FIGS. 1A-1C and 2A-2B.

FIG. 4 is a front right perspective view of a battery of the modular power systems of FIGS. 1A-1C and 5A-5B.

FIG. 5A is a front right perspective view of an exemplary modular power system.

FIG. 5B is a rear right perspective view of the modular power system of FIG. 5A.

### DETAILED DESCRIPTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed devices and methods. Such other components not described herein may include, but are not limited to, for example, components developed after development of the disclosed technology.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values±20% of the recited value, e.g. “about 90%” may refer to the range of values from 71% to 99%.

It is also to be understood that the mention of one or more method steps does not preclude the presence of additional method steps or intervening method steps between those steps expressly identified.

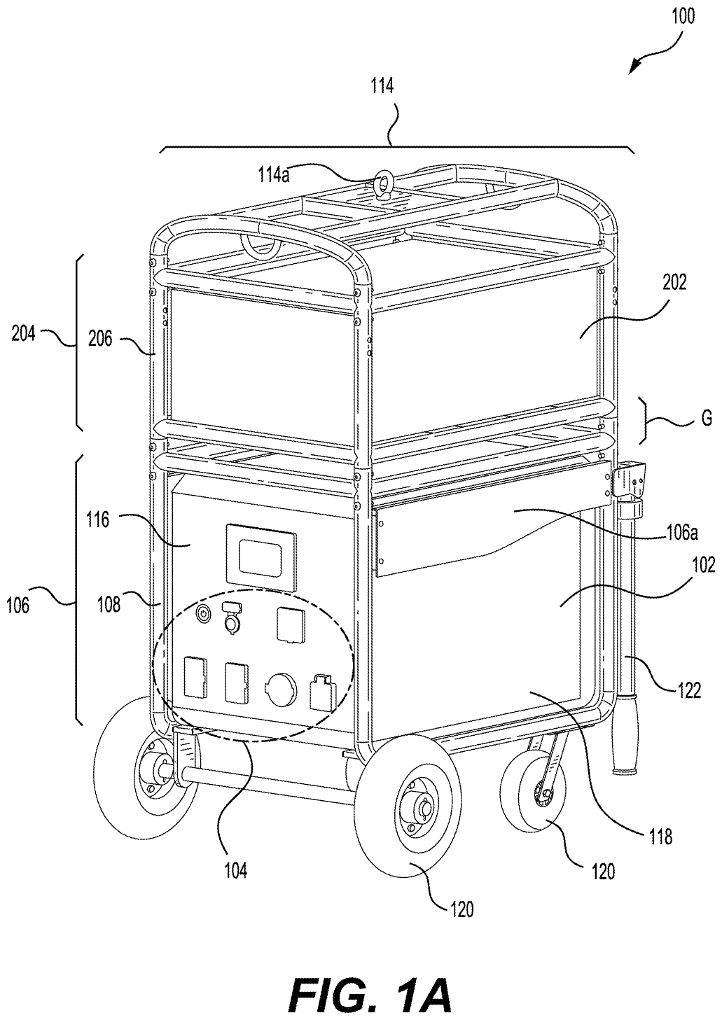

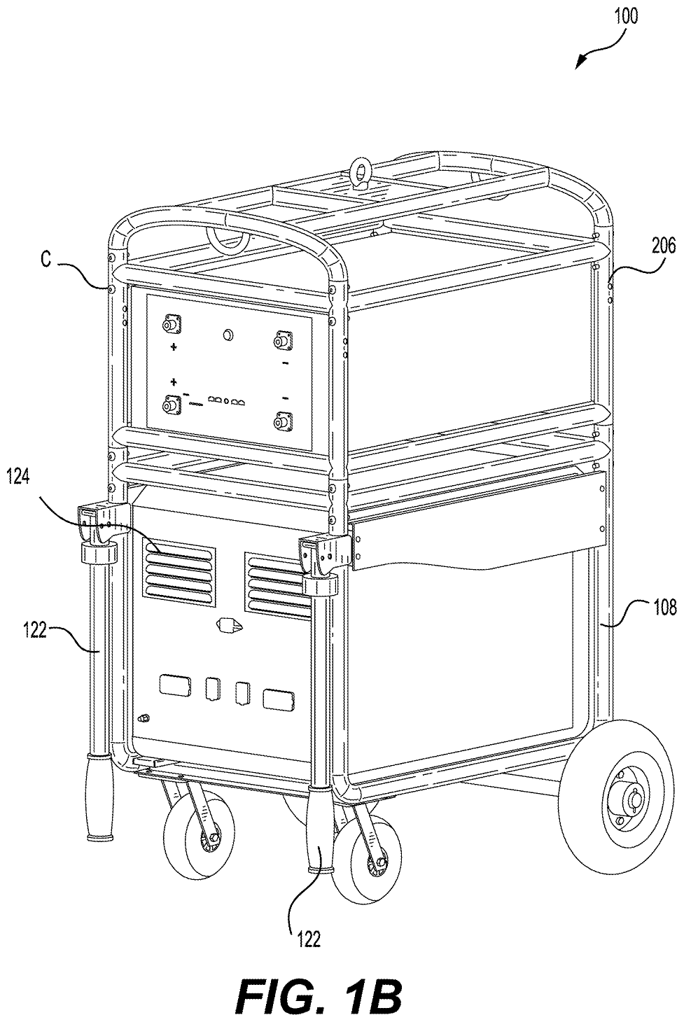

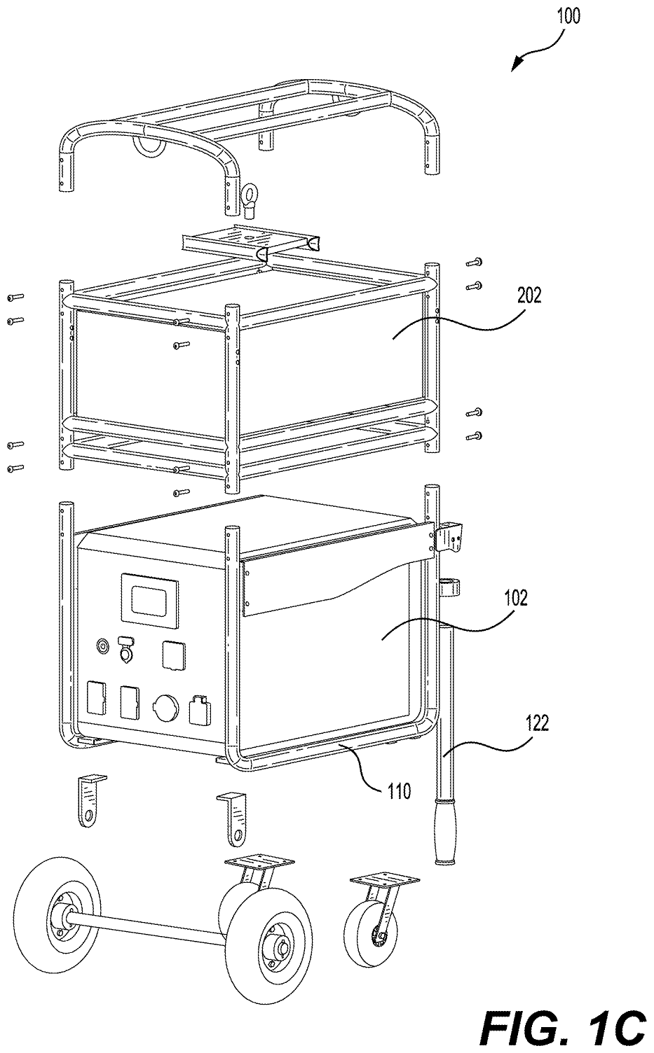

Reference will now be made in detail to exemplary embodiments of the disclosed technology, examples of which are illustrated in FIGS. 1A-1C, 2A-2B, 3A-3B, 4, and 5A-5B, and disclosed herein. Wherever convenient, the same reference numbers will be used throughout the drawings to refer to the same or like parts.

FIGS. 1A-1C, 2A-2B, 3A-3B, 4, and 5A-5B illustrate variations of and/or individual components of the modular power systems of the present invention, and as such, are described simultaneously herein.

FIGS. 1A-1C depict an embodiment of a modular power system 100 in accordance with the present invention. As shown, a modular power system 100 may include a power station 102 including an inverter 116. In some embodiments, the power station 102 may optionally include a battery 118. The inverter 116 is configured to convert direct current (DC) voltage of the battery 118 and/or one or more modular batteries (further discussed below) to one or more alternating current (AC) voltage outputs of the power station 102. The power station 102 may further include a converter configured to convert an AC voltage to the DC voltage to charge the battery 118 of the power station 102 and/or one or more modular batteries from an AC voltage source (e.g., wall outlet or generator). The power station 102 may further include one or more DC to DC converters configured to convert a DC voltage of the battery 118 and/or one or more modular batteries to one or more DC voltage outputs of the power station 102. The power station 102 may further include one or more DC to DC converters configured to charge the battery 118 and/or one or more modular batteries from a DC power source (e.g., solar panel). For the sake of simplifying discussion, as used herein, the term “inverter” and illustrations of an inverter (e.g., inverter 116) are to be construed broadly to include one or more of a DC to AC inverter, an AC to DC converter, and/or a DC to DC converter such that operation of the inverter 116 (AC to DC, DC to AC, or DC to DC) is understood by a person skilled in the art based on the context of use within the present disclosure.

In some embodiments, the battery 118 may have one of a variety of power ratings (e.g., a 5,000 Watt (W) power rating), and/or may be either an iron air, iron nickel, or lithium-ion battery. In some embodiments, the battery 118 may include a fuel cell configured to produce an electric current directly from a chemical reaction. In some embodiments, the battery 118 may include any suitable chemistry and construction suitable to function as a rechargeable battery.

In some embodiments, power station 102 may include one or more power ports 104. Power port(s) 104 may include a variety of types of power ports, such as AC outlets (e.g., 120 Volt (V), 240V etc.), universal serial bus (USB) outlets (e.g., USB-C, USB-A, etc.), DC outlets (e.g., 5V, 12V, 24V, etc.), wireless charging pads (e.g., 15 W), and the like.

In some embodiments, the modular power system 100 may include a first rigid frame 106 configured to house and/or protect the power station 102. The first rigid frame 106 may include one or more first interlocking struts 108 configured to fit together to form the first rigid frame 106. The first rigid frame 106 may further include one or more support components 106a configured to provide additional structural support. A rigid frame, as used in certain examples, can enclose the power station 102 and first battery 202, etc. but is in addition to the structure that encapsulates those elements. The power station 102 and first battery 202, etc. are separable from the rigid frame and can be removed or placed into the rigid frame without exposing interior components thereof.

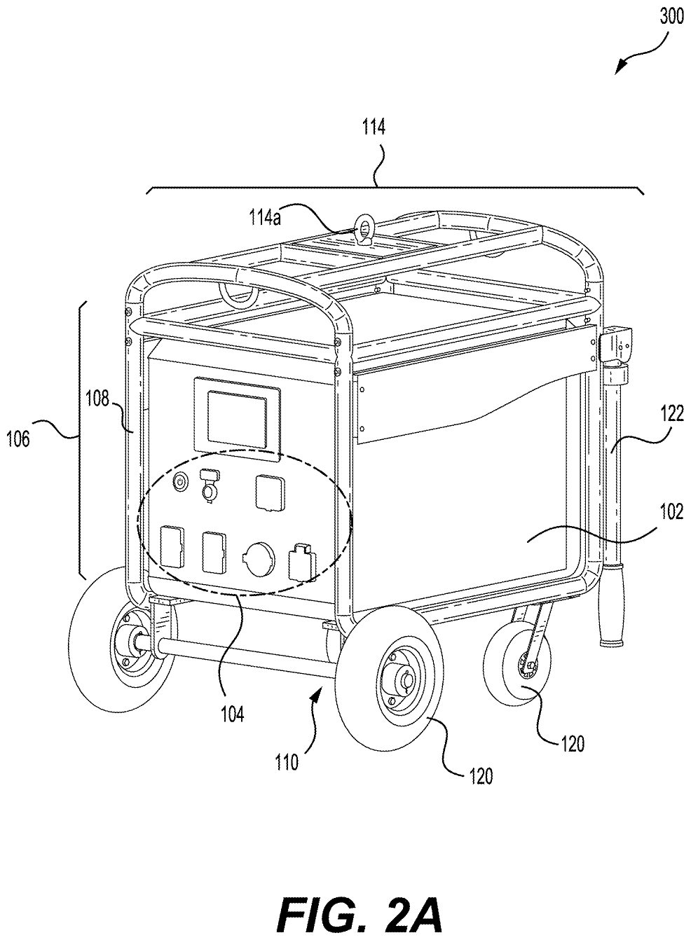

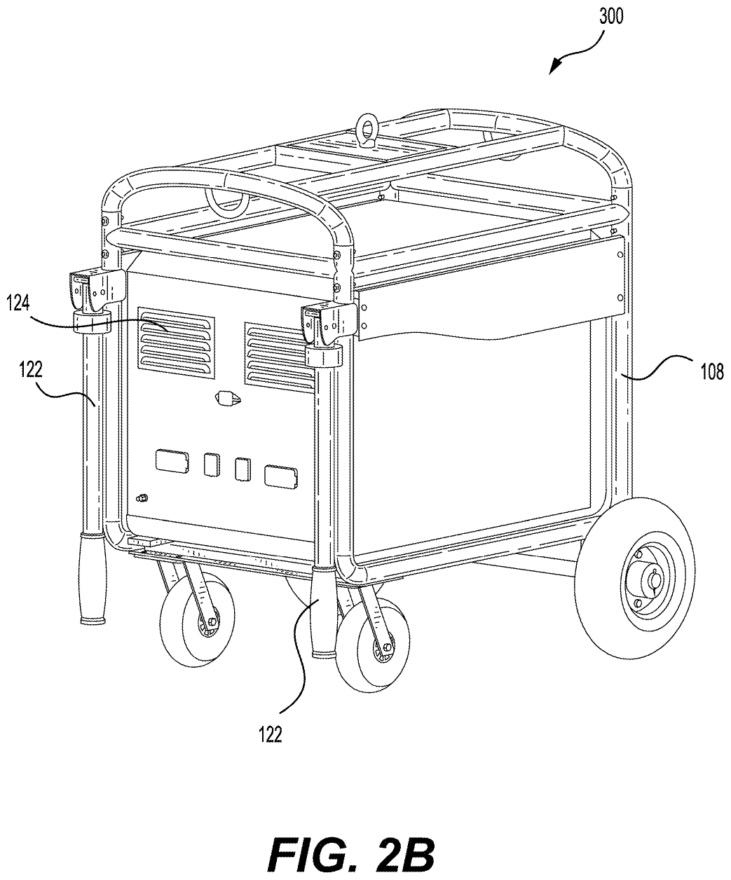

FIGS. 2A-2B depict another embodiment of a modular power system 300 in accordance with the present invention. Modular power system 300 may be the same as or similar to modular power system 100, except that modular power system 300 may include only the power station 102, the first rigid frame 106, the bottom frame 110, and the top frame 114. That is, there may be instances where mounting (e.g., stacking) one or more modular batteries proximate to (e.g., on top of, beneath, next to, etc.) power station 102 is not required, as discussed herein. In some embodiments, at least one of the first rigid frame 106, the bottom frame 110, and the top frame 114 may be configured to removably interlock with at least the other of the first rigid frame 106, the bottom frame 110, and the top frame 114.

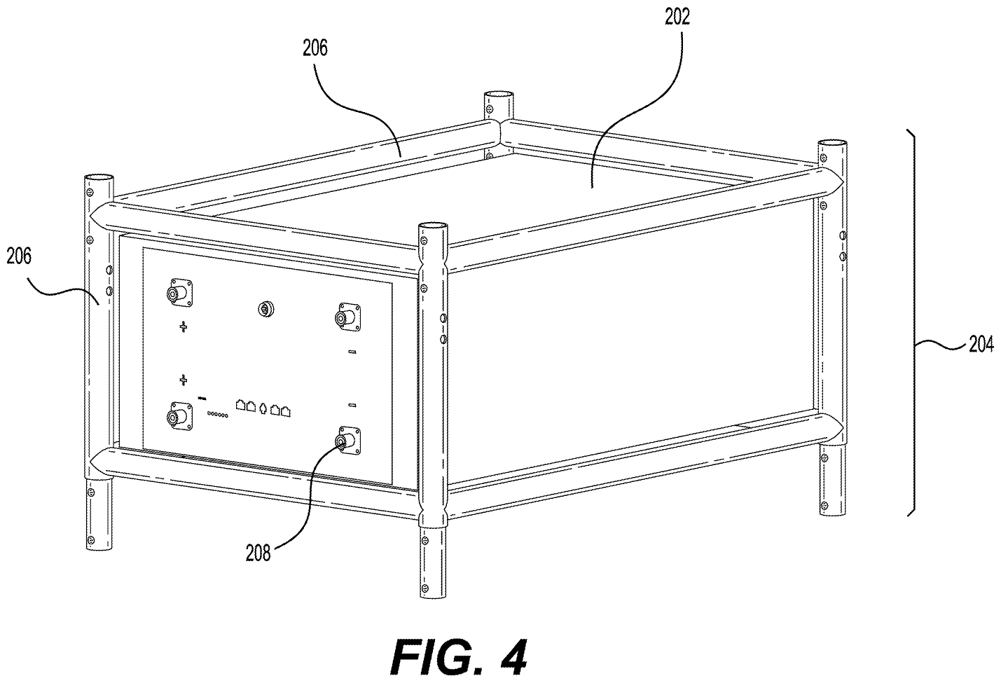

In some embodiments, as particularly shown in FIGS. 1A-1B and 4, the modular power system 100 may include a first battery 202, for example, a 5,000 W battery, configured to be stacked on top of the power station 102. The first battery 202 may be electronically connected to the power station 102 such that the overall capacity of the modular power system 100 may be increased. That is, one or more first batteries 202 may be stacked on top of the power station 102 depending on the desired overall capacity of the modular power system 100.

In some embodiments, the modular power system 100 may include a second rigid frame 204 configured to engage the first rigid frame 106, and to house and/or protect the first battery 202. The second rigid frame 204 may include one or more second interlocking struts 206 configured to fit together to form the second rigid frame 204. As particularly shown in FIGS. 1A-1B, the second interlocking struts 206 of the second rigid frame 204 may be configured to interlock with the first interlocking struts 108 of the first rigid frame 106 when the first battery 202 is stacked on top of the power station 102.

Interlocking between struts within the same frame or between the first and second rigid frames 106, 204 can entail struts designed to structurally engage with one another. The struts can be connected by pins, bolts, bayonet or detent connectors C, or by other means known in the art, as particularly shown in FIGS. 1B, 2A, and 3A. This can allow the struts to act as a continuous frame to secure the power station 102, the first battery 202, etc. together for both transportation and protection.

In some embodiments, the power station 102 and/or the first battery 202 may be configured to be charged via AC power and/or solar energy, such as via a connected solar panel.

In some embodiments, the power station 102 may include one or more vents 124 configured to aid in preventing the power station 102 from overheating.

In some embodiments, as particularly shown in FIG. 4, the first battery 202 may include one or more input ports 208 configured to attach to cables that can be run between the power station 102 and/or modular first batteries 202 for AC charging, solar panel charging, and/or charging of modular first batteries 202. For example, as shown in FIGS. 1A-1B, power station 102 and first battery 202 can be connected via input ports 208 such that power station 102 can charge the first battery 202, as discussed above.

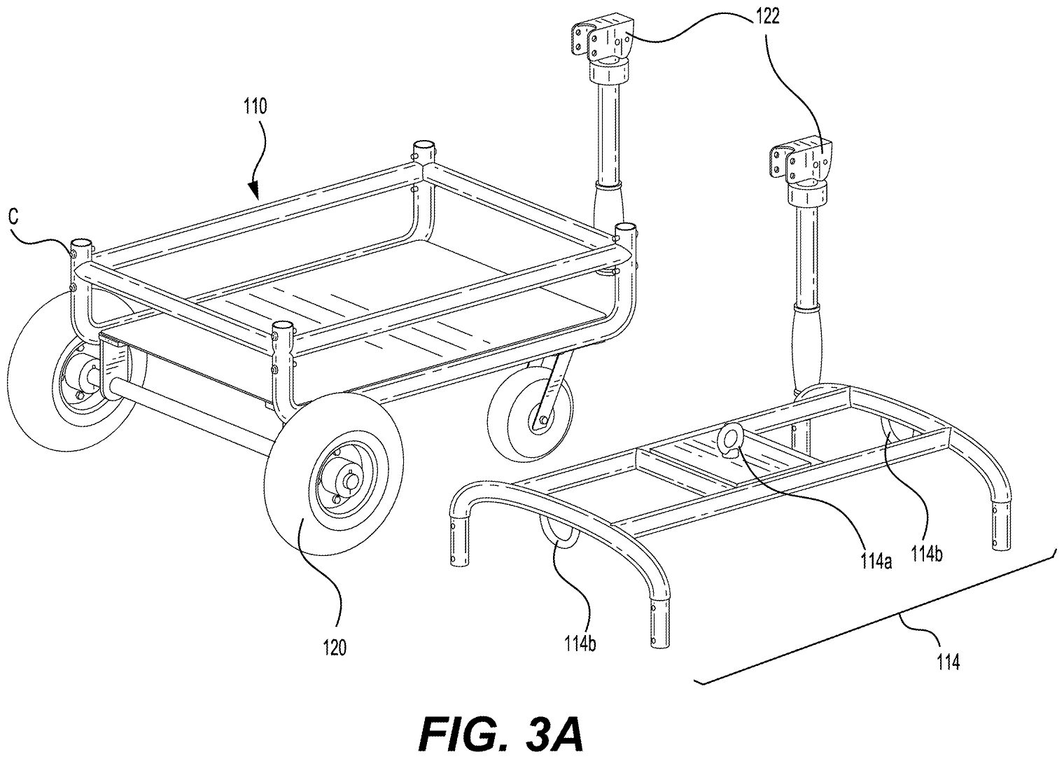

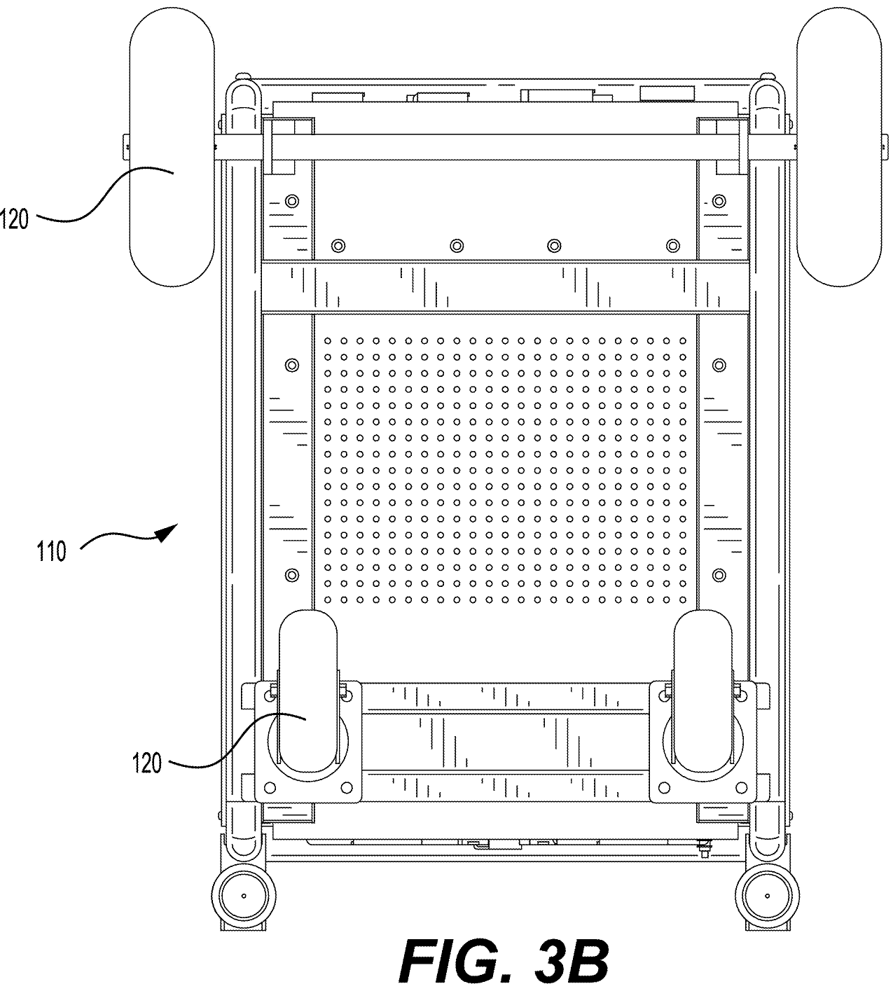

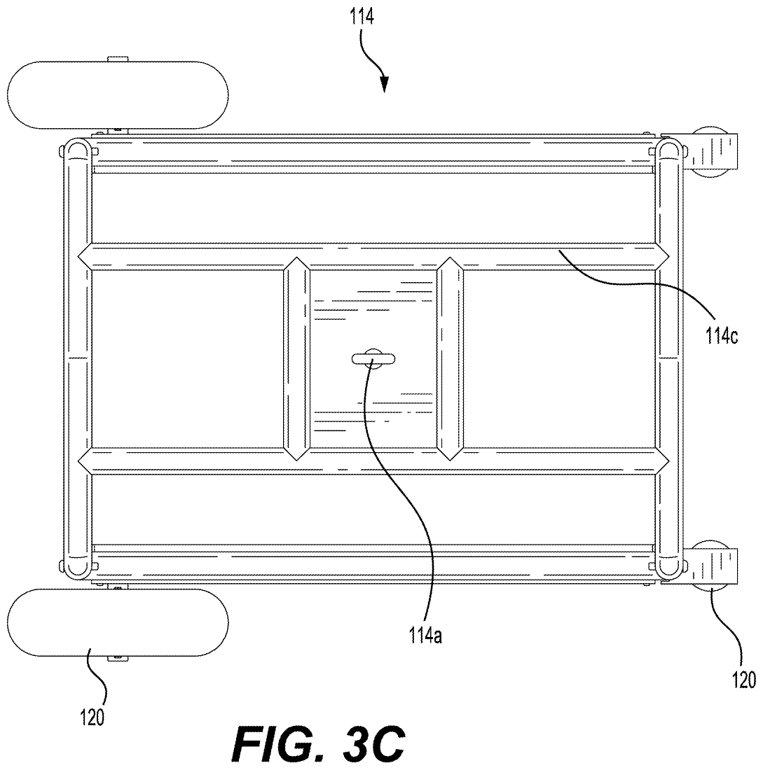

In some embodiments, as particularly shown in FIGS. 3A and 3B, the modular power system 100 may include a bottom frame 110, which may be configured to interlock with the first rigid frame 106. The bottom frame 110 may include different transportation elements.

In one example, the transportation elements can be two or more wheels 120 that may range in size and placement on the bottom frame 110. For example, one or more wheels 120 may be disposed on one side, e.g., the front, of the bottom frame 110, while one or more wheels 120 may be disposed on the opposite side, e.g., the back, of the bottom frame 110. As particularly shown in FIGS. 1A-1B, wheel(s) 120 disposed on the front side of the bottom frame 110 may be larger in size than the wheel(s) 120 disposed on the back side of the bottom frame 110. The wheel(s) 120 can be connected by an intervening axel or fixed individually. Alternately, or in addition to, the wheel(s) 120 can be casters and allowed to swivel. The configuration of the wheel(s) 120 can allow the bottom frame 110 to be transported similarly to a wheelbarrow or as a cart. Further, the wheel(s) 120 can be ruggedized to allow for transport of the power system 100 over uneven terrain or onto a construction site.

Further, the bottom of the bottom frame 110 can also have alternate transportation elements. Skis can be mounted on the bottom frame 110 is lieu of, or in addition to the wheels for transport over snow or other icy terrain. Tracks for making the bottom frame tracklaying can also be installed. A motor (not illustrated) can also be used to drive the wheel(s) or tracks. The motor can be independently powered (using any conventional means) or powered from the power system 100. The bottom frame 110 can also have forklift fork attachments to allow the power system 100 to be transported or raised by forklift.

In some embodiments, as particularly shown in FIGS. 1A and 3A, the modular power system 100 may include a top frame 114 opposite the bottom frame 110. The top frame 114 may include a hoist hook 114a (e.g., an eye hook) and/or one or more sling holes 114b. The hoist hook 114a and sling hole(s) 114b may provide for enhanced mobility of the modular power system 100 as they may allow the system to be, for example, hoisted upward (e.g., onto an upper floor of a building), and/or pulled/pushed in certain directions.

In some embodiments, as particularly shown in FIG. 3C, the top frame 114 may include one or more third interlocking struts 114c. The number, size, and/or orientation of the third interlocking strut(s) 114c may be configured to sufficiently support the size and weight of modular power station 100.

In some embodiments, the top frame 114 may have a dome shape. In some embodiments, the top frame 114 may be removable such that it can be detached from, for example, the first rigid frame 106 (FIGS. 2A-2B) in order to stack one or more first batteries 202 onto the power station 102 (FIGS. 1A-1C). The top frame 114 may then be re-attached to the respective second rigid frame 204 of whichever first battery 202 is the highest stacked.

In some embodiments, when the first battery 202 is mounted proximate to (e.g., stacked on top of) the power station 102, as discussed herein, the first rigid frame 106 and the second rigid frame 204 may form a gap G between the power station 102 and the first battery 202. This gap G may help to prevent the power station 102 and/or first battery 202 from overheating or becoming damaged if the components were sitting directly against one another.

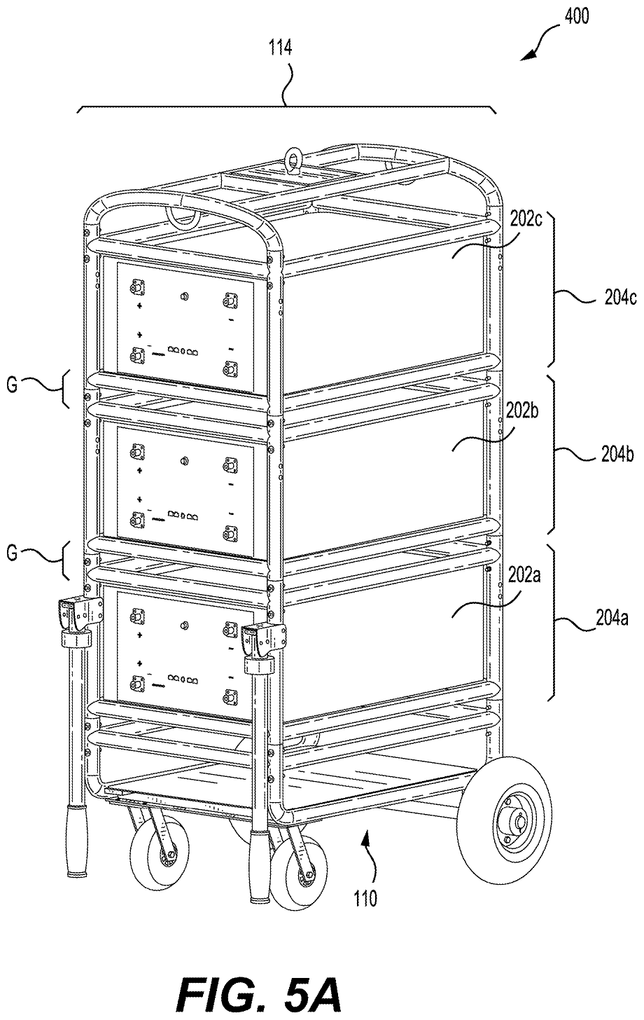

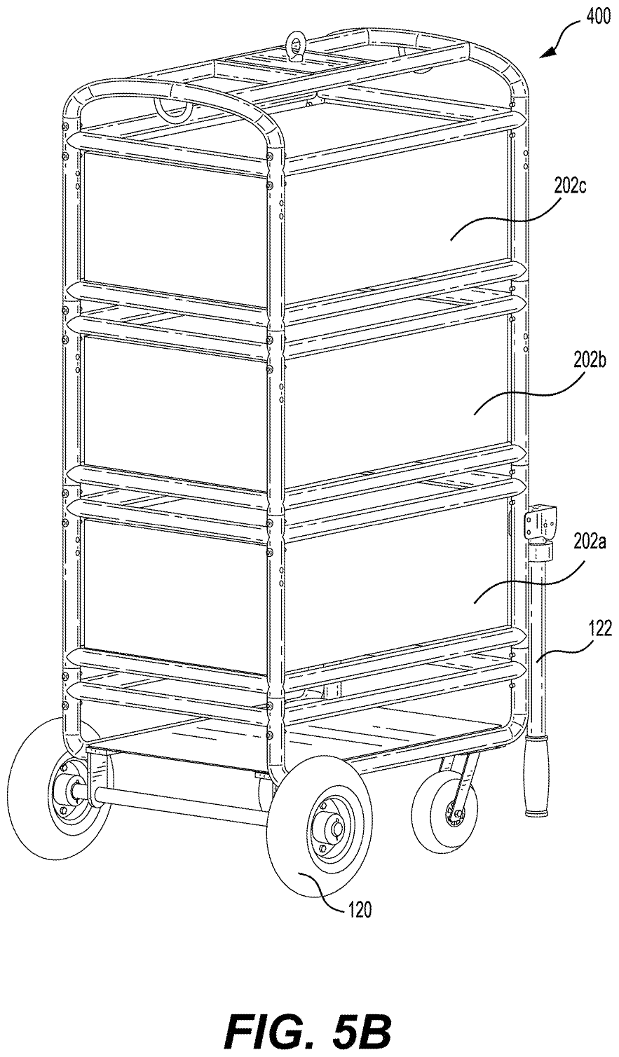

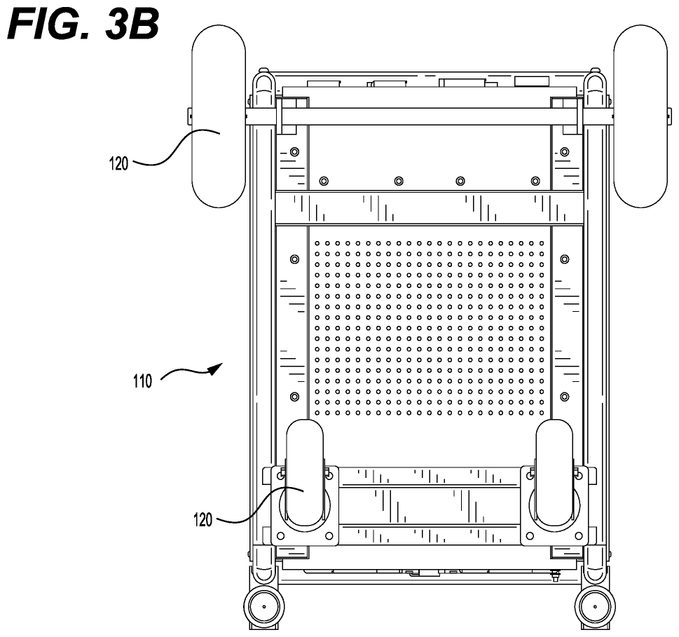

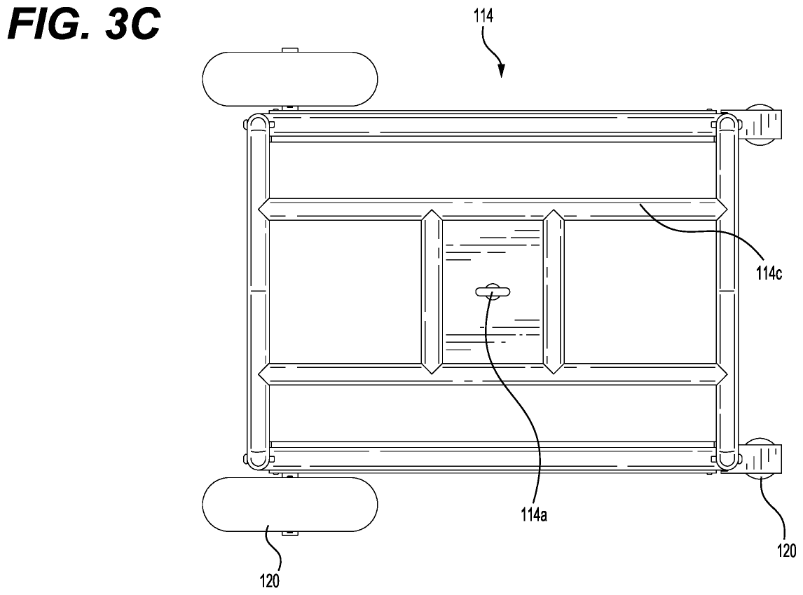

In some embodiments, two or more first batteries 202 may be mounted proximate to (e.g., stacked on top of) power station 102. Each of the first batteries 202 may have a respective second rigid frame 204, as particularly shown in FIGS. 5A-5B. In such embodiments, the respective second interlocking struts 206 of each second rigid frame 204 may be configured to interlock with the first interlocking struts 108 of the first rigid frame 106 and/or the respective second interlocking struts 206 of the other second rigid frames 204.

In some embodiments, the modular power system 100 may include one or more handles 122 configured to aid in pushing and/or pulling the modular power system 100. The handle(s) 122 may be foldable in that they may be configured to be placed in a vertical orientation when the modular power system 100 is in a stored or stationary position, and in a horizontal orientation, or angled outward, when the modular power system 100 is being moved. This feature may aid in the ability to store modular power system 100 in tighter spaces. Further, either separately, or as part of the handle 122, the modular power system 100 may include a hitch to engage the back of a vehicle for ease of transport.

FIGS. 5A-5B depict an embodiment of a modular power system 400 in accordance with the present invention. Modular power system 400 may be the same as or similar to modular power systems 100 and 300 discussed herein; however, modular power system 400 may include one or more first batteries 202 (e.g., 202a, 202b, 202c, etc.) stacked on top of one another even in absence of the power station 102. For example, the stackable nature of the first batteries 202 may provide a benefit of a user easily able to transport the first batteries 202, such as ones already fully charged, within their respective second rigid frames (e.g., 204a, 204b, 204c, etc.).

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A modular power system comprising:
a power station;
a first rigid frame configured to house the power station;
a second rigid frame configured to engage the first rigid frame;
a first battery configured to be mounted proximate to the power station and housed in the second rigid frame;
a bottom frame engaging the first rigid frame and comprising a transportation element; and
a top frame engaging the second rigid frame.

2. The modular power system of claim 1, wherein the modular power system is configured such that the first rigid frame and the second rigid frame form a gap between the power station and the first battery when the first battery is mounted proximate to the power station.

3. The modular power system of claim 1, wherein the power station comprises an inverter.

4. The modular power system of claim 3, wherein the power station comprises a second battery.

5. The modular power system of claim 4, wherein the second battery comprises 5,000 Watts.

6. The modular power system of claim 4, wherein the second battery comprises at least one of an iron-air, a nickel-iron or a lithium-ion battery.

7. The modular power system of claim 4, wherein the second battery comprises a fuel cell.

8. The modular power system of claim 1, wherein the first battery is configured to be electronically connected to the power station.

9. The modular power system of claim 1, wherein the first battery comprises 5,000 Watts.

10. The modular power system of claim 1, wherein the power station and the first battery are configured to be charged using at least one of alternating current (AC) power and solar energy.

11. The modular power system of claim 1, wherein the power station comprises one or more power ports.

12. The modular power system of claim 1, wherein:
the first rigid frame comprises one or more first interlocking struts;
the second rigid frame comprises one or more second interlocking struts; and
the one or more second interlocking struts of the second rigid frame are configured to interlock with the one or more first interlocking struts of the first rigid frame.

13. The modular power system of claim 12, further comprising:
two or more first batteries and two or more second rigid frames configured to respectively house the two or more first batteries,
wherein the one or more second interlocking struts of a first respective second rigid frame of the two or more second rigid frames are configured to interlock with the one or more second interlocking struts of a second respective second rigid frame of the two or more second rigid frames.

14. The modular power system of claim 1, wherein:
the top frame is removable; and
a second battery is mounted proximate to the power station and the first battery by:
removing the top frame from the first rigid frame;
stacking the second battery on top of the first battery; and
re-attaching the top frame to a third rigid frame of the second battery.

15. The modular power system of claim 1, wherein the top frame comprises a dome shape.

16. The modular power system of claim 1, wherein the top frame comprises at least one of a hoist hook and one or more sling holes.

17. The modular power system of claim 1, further comprising a foldable handle.

18. A modular power system comprising:
a power station comprising an inverter;
a first rigid frame configured to house the power station;
a bottom frame comprising a transportation element and interlocking to the first rigid frame; and
a top frame interlocking to the first rigid frame opposite the bottom frame.

19. The modular power system of claim 18, wherein at least one of the first rigid frame, the bottom frame, and the top frame removably interlocks with at least the other of the first rigid frame, the bottom frame, and the top frame.

20. The modular power system of claim 18, further comprising:
a first battery configured to be mounted proximate to and electronically connected to the power station; and
a second rigid frame configured to house the first battery,
wherein the modular power system is configured such that the first rigid frame and the second rigid frame form a gap between the power station and the first battery when the first battery is mounted proximate to the power station.
